(19) United States
(12) Patent Application Publication
(10) Pub. No.: US 2005/0264690 A1
(43) Pub. Date: Dec. 1, 2005

(54) Image sensor

(75) Inventors: Pei-Hsun Pan, Junghe City (TW); Cheng-Te Tseng, Junghe City (TW); Chung-Yi Tsai, Junghe City (TW)

Correspondence Address: TROXELL LAW OFFICE PLLC;SUITE 1404, 5205 LEESBURG PIKE, FALLS CHURCH, VA, 22041, US

(73) Assignee: Tekom Technologies, Inc.

(21) Appl. No.: 10/855,648

(22) Filed: May 28, 2004

(51) Int. Cl. H04N 5/225

(52) U.S. Cl. 348/374

(57) ABSTRACT

Present invention is an image sensor, comprising a body with a first lens, a second lens and a sensor, wherein a channel is between the first lens and the sensor; and wherein the second lens is on the first lens. Accordingly, by the piled-up lenses, the image sensor is able to do focusing and to achieve special optical effects.

### FIELD OF THE INVENTION

Present invention relates to an image sensor; more particularly, relates to an image sensor with functions of focusing as well as special optical effects.

### DESCRIPTION OF THE RELATED ART

As is known, an image sensor of a related art comprises a body 30 with a socket 31, wherein the socket 31 comprises a sensor 32; wherein the sensor is wirebonded 33 with the inner edge of the socket 31; and, wherein a glass plate is on the cover of the socket.

[symbol] @ [symbol] @As shown in FIG. 6, an image sensor of another related art comprises a body 40 with an aperture 41, wherein the aperture 41 comprises a flange 42; wherein a glass sheathing 43 tightly covers on the upper end of the flange 42; and wherein a sensor 44 is on the other end of the flange 42.

Though the above two image sensor can do image sensing, each of these two image sensors uses a glass plate 33 (glass sheathing 43) to protect the sensor and to filter the light. When sensing the image, special optical effects or the functions like focusing are not available so that the images aquired are rather boring. Accordingly, related arts do not fulfill users' requests.

### BRIEF SUMMARY OF THE INVENTION

Therefore, the purpose of the present invention is that, by piled-up lenses, the image sensor is able to do focusing.

Another purpose of the invention is that, by piled-up lenses, the image sensor can achieve special optical effects.

To achieve the above purposes, the present invention is an image sensor, comprising a body with a first supporter on one end; a second supporter and a third supporter on the other end of the body; a channel connecting the first supporter and the second supporter; a sensor on the first supporter; a first lens on the second supporter; and a second lens on the third supporter piled-up with the first lens. Accordingly, by piling up the lenses, the image sensor is able to do focusing as well as special optical effects.

### BRIEF DESCRIPTION OF THE DRAWINGS

The present invention will be better understood from the following detailed description of a preferred embodiment of the invention, taken in conjunction with the accompanying drawings, in which

FIG. 1 is a perspective view of the first preferred embodiment according to the present invention;

FIG. 2 is an exploded view of the structure of the first preferred embodiment according to the present invention;

FIG. 3 is a perspective view of the second preferred embodiment according to the present invention;

FIG. 4 is an exploded view of the structure of the second preferred embodiment according to the present invention;

FIG. 5 is a perspective view of the related art; and

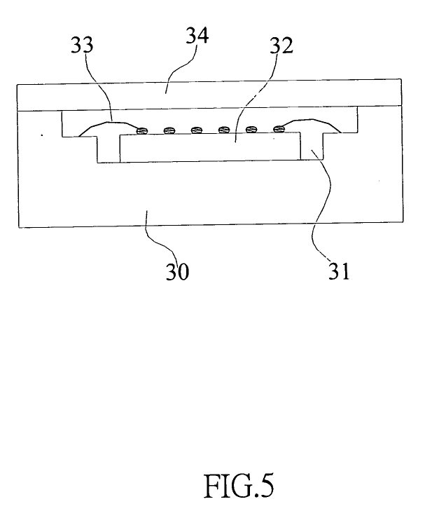

FIG. 6 is another perspective view of the related art.

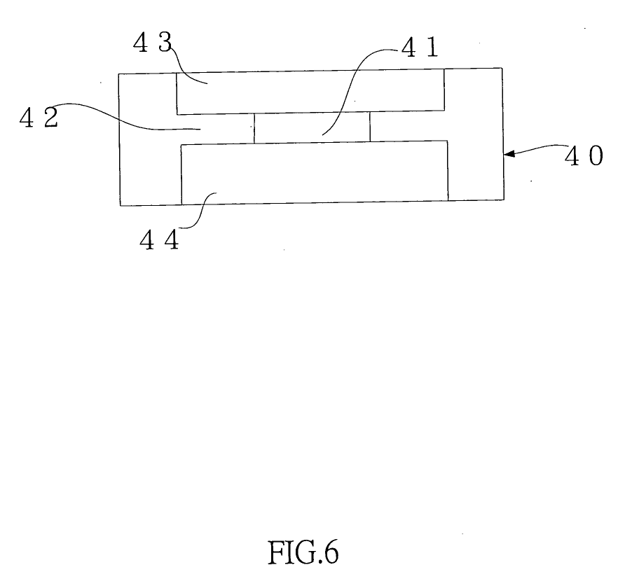

### DESCRIPTION OF THE PREFERRED EMBODIMENT

The following descriptions of the preferred embodiment are provided to understand the features and the structures of the present invention.

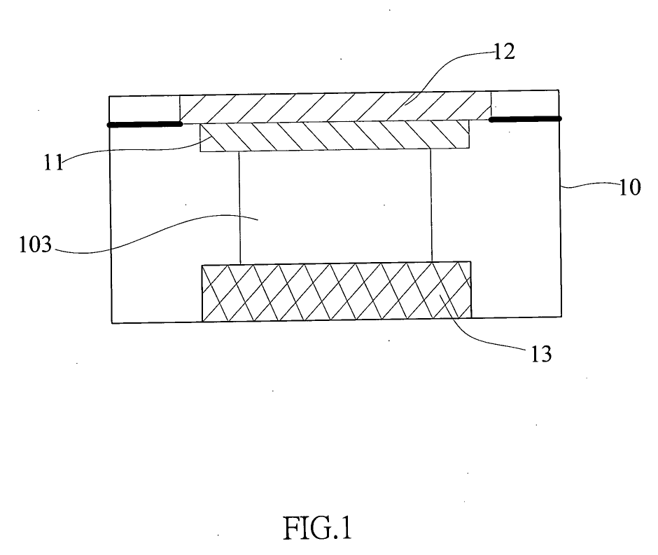

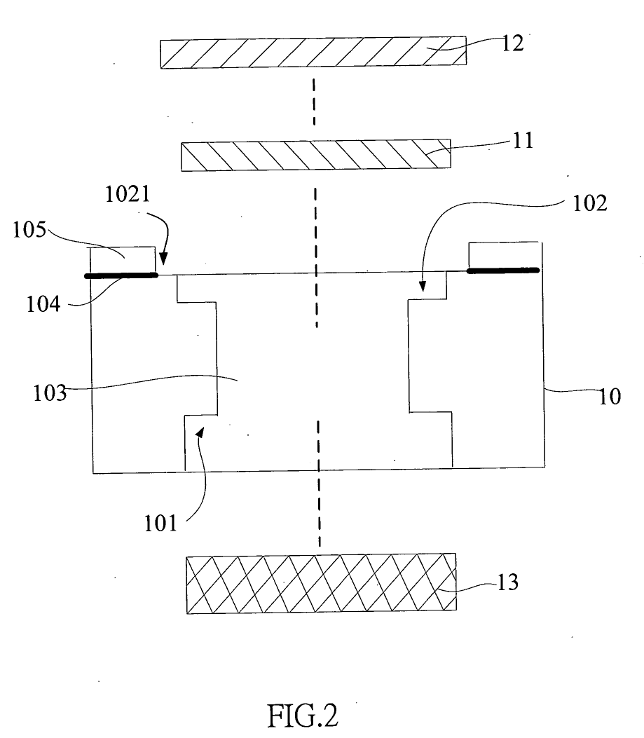

Please refer to FIG. 1 and FIG. 2, which are the perspective view and the exploded structure view of the first preferred embodiment according to the present invention. As shown in the figures, present invention is an image sensor comprising a body 10, a first lens 11, a second lens 12 and a sensor 13.

The body 10 comprises a first supporter 101 on one end; a second supporter 102 and a third supporter 1021 on the other end; a channel 103 connecting the first supporter 101 and the second supporter 102; and a metal-wired connecting layer 104 on the surface of the body 10 near the second supporter 102. The metal-wired connecting layer 104 can comprise a printed circuit board (PCB) 105, wherein the circuit for the image sensor can be connected on it to save circuit area.

The first lens 11 is on the second supporter 102 and the first lens 11 can be a magnifying cover glass.

The second lens 12 is on the third supporter 1021 with the PCB 105 rounded the outer edge and it can be a camera lens of a magnifying glass with special functions.

The sensor is on the first supporter 101 and can be a charge-coupled device (CCD) or a complementary metal-oxide-silicon (CMOS). Accordingly, a novel image sensor is made. On using, by the piling-up of the first lens 11 and the second lens 12, focusing and special optical effects like local image magnification can be achieved.

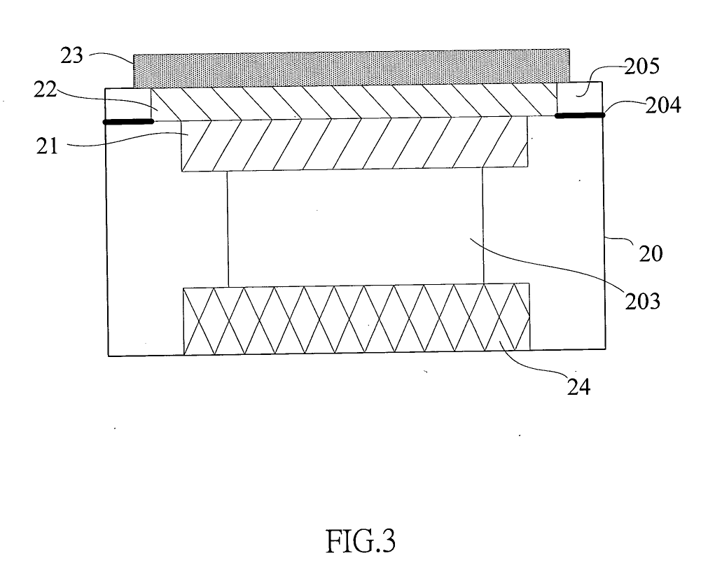

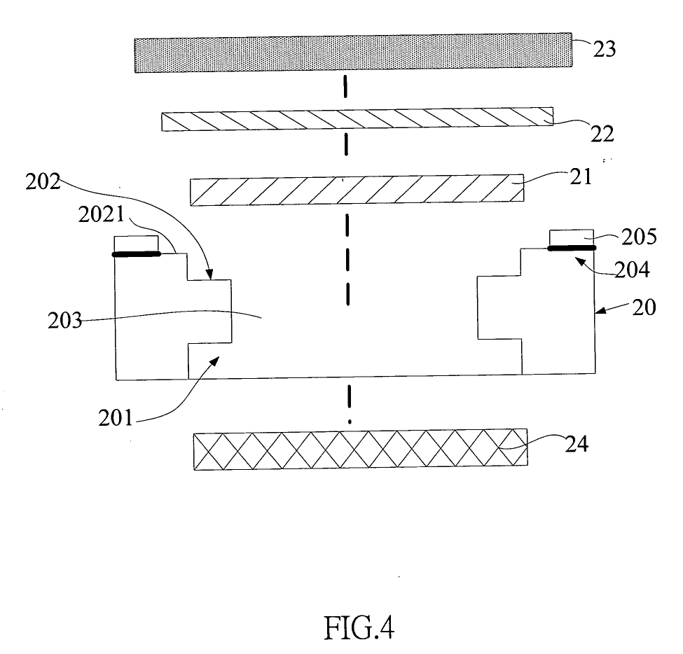

Please refer to FIG. 3 and FIG. 4, which are a perspective view and an exploded structure view of the second preferred embodiment according to the present invention. As shown in the figures, the present invention comprises a body 29, a first lens 21, a second lens 22, a third lens 23 and a sensor 24, to achieve the functions of focusing and special optical effects as the first embodiment does.

The body 20 comprises a first supporter 201 on one end; a second supporter 202 and a third supporter 2021 on the other end; a channel 203 connecting the first supporter 201 and the second supporter 202; and a metal-wired connecting layer 204 on the surface of the body 20 near the second supporter 202. The metal-wired connecting layer 204 can comprise a PCB 205 so that no outer circuit is required for the image sensor and the circuit area is saved.

The first lens 21 is on the second supporter 202 and the first lens 21 can be a magnifying cover glass.

The second lens 22 is on the third supporter 2021 with the PCB 205 rounded the outer edge and it can be a camera lens of a magnifying glass with special functions.

The third lens 23 can be on the PCB 205, and can be a Fresnel lens, an anti-reflection coating or a magnifying glass.

The sensor 24 is on the first supporter 201 and can be a CCD or a CMOS. On using, by piling up the first lens 21, the second lens 22 and the third lens 23, focusing and special optical effects like local image magnification can be achieved. Accordingly, by applying different lenses under the structure of the present invention, no extra lens is required to achieve different special optical effects according to the requirements, like depth of field or wide angle.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

1. An image sensor, comprising:
a body comprising a first supporter on one end of said body, a second supporter and a third supporter on the other end of said body, and a channel connecting said first supporter and said second supporter;
a sensor on said first supporter;
a first lens on said second supporter; and
a second lens on said third supporter.

2. The image sensor as claim 1, wherein a metal-wired connecting layer is on an end surface of said body near said second supporter and a printed circuit board (PCB) is on said layer rounded the outer edge of said second lens.

3. The image sensor as claim 1, wherein said first lens is a magnifying cover glass.

4. The image sensor as claim 1, wherein said second lens is a camera lens of a magnifying glass with special functions.

5. The image sensor as claim 1, wherein a third lens is on said second lens.

6. The image sensor as claim 5, wherein said third lens is a fresnel lens.

7. The image sensor as claim 5, wherein said third lens is an anti-reflection coating (ARC).

8. The image sensor as claim 5, wherein said third lens is a magnifying glass.

9. The image sensor as claim 1, wherein said sensor is a charge-coupled device (CCD).

10. The image sensor as claim 1, wherein said sensor is a complementary metal-oxide-silicon (CMOS).

11. An image sensor, comprising:
a body comprising a PCB, a first supporter on one end of said body, a second supporter and a third supporter on the other end of said body, and a channel connecting said first supporter and said second supporter;
a sensor on said first supporter;
a first lens on said second supporter;
a second lens on said third supporter; and
a third lens on said PCB.

12. The image sensor as claim 11, wherein a metal-wired connecting layer is on a surface of said body near said second supporter and a PCB is on said layer rounded the outer edge of said second lens.

13. The image sensor as claim 11, wherein said first lens is a magnifying cover glass.

14. The image sensor as claim 11, wherein said second lens is a camera lens of a magnifying glass with special functions.

15. The image sensor as claim 11, wherein said third lens is a fresnel lens.

16. The image sensor as claim 11, wherein said third lens is an ARC.

17. The image sensor as claim 11, wherein said third lens is a magnifying glass.

18. The image sensor as claim 11, wherein said sensor is a CCD.

19. The image sensor as claim 11, wherein said sensor is a CMOS.
